(19) United States
(12) Patent Application Publication
(10) Pub. No.: US 2016/0031500 A1
(43) Pub. Date: Feb. 4, 2016

(54) SYSTEM INCLUDING A WHEEL AND A REPLACEABLE WEAR PAD

(71) Applicant: Hutchinson S.A., Paris (FR)

(72) Inventors: Christopher R. Renson, Langhorne, PA (US); Lars Johan Resare, Ewing, NJ (US); Dawn M. DiMarco, Newtown, PA (US); Larry W. Stuck, Amherst, NY (US); Jason M. Scala, Moorestown, NJ (US); Peter K. Hobe, Levittown, PA (US)

(21) Appl. No.: 14/812,543

(22) Filed: Jul. 29, 2015

Related U.S. Application Data
(60) Provisional application No. 62/030,101, filed on Jul. 29, 2014.

(51) Int. Cl. B62D 55/14

(52) U.S. Cl. CPC B62D 55/145

(57) ABSTRACT

A system. The system includes a wheel, a plurality of carrier members and a plurality of wear pads. Each of the plurality of carrier members are removably connected to the wheel. Each carrier member has at least one of the wear pads connected thereto.

### CROSS-REFERENCE TO RELATED APPLICATION

This application claims the benefit under 35 U.S.C. §119(e) of the earlier filing date of U.S. Provisional Patent Application No. 62/030,101 filed on Jul. 29, 2015, the content of which is hereby incorporated by reference in its entirety.

### BACKGROUND

This application discloses an invention which is related, generally and in various embodiments, to a system including a wheel and a wear pad.

It is known to utilize solid rubber tires with the road wheels of tracked vehicles. An example of these rubberized road wheels is shown in FIG. 1, which shows four sets of rubberized road wheels, where a given set includes an inboard road wheel and an outboard road adjoined and rotating about a common axis. In general, such tracked vehicles have tracks comprised of individual track units linked together in a continuous loop. The road wheels roll upon the track units as the track units engage the ground. The road wheels are aligned with the track by center guides (track teeth) projecting from the track units into a track guide channel space between the side surfaces of the road wheels. Wear rings are affixed to the side surfaces of the tracked vehicle road wheels in the track guide channel groove and interface with the track guide. The wear rings prevents abrasion of the road wheels and extend the life of the road wheels.

The rubberized road wheels collectively operate to transfer the radial load of the vehicle through the respective hub attachments, through the disk area of the road wheels, through the rim area of the road wheels and through the solid rubber tires to the track underneath the solid rubber tires.

Over time, the solid rubber tires wear down to the point where they need to be replaced in order to maintain their effectiveness. Typically, the replacement procedure includes bringing the tracked vehicle in to a maintenance center or depot, removing the road wheels, removing the solid rubber tires from the road wheels, cleaning and treating the road wheels, and installing new rubber tires on the road wheels. By having to bring the tracked vehicle to a maintenance center or depot, and by having to remove a given wheel to replace its corresponding rubber tire, even if only a small portion of the rubber tire is damaged or worn, the typical replacement process is relatively time consuming, relatively costly, and relatively inefficient.

### BRIEF DESCRIPTION OF THE DRAWINGS

Various embodiments of the invention are described herein in by way of example in conjunction with the following figures, wherein like reference characters designate the same or similar elements.

FIG. 1 illustrates a prior art tracked vehicle;

FIG. 2 illustrates various embodiments of a system;

FIG. 3 illustrates various embodiments of a system;

FIG. 4 illustrates various embodiments of a system;

FIG. 5 illustrates various embodiments of a system;

FIG. 6 illustrates various embodiments of a system;

FIG. 7 illustrates various embodiments of a system;

FIG. 8 illustrates various embodiments of a system;

FIG. 9 illustrates various embodiments of a system;

FIGS. 10 and 11 illustrate various embodiments of a system;

FIG. 12 illustrates various embodiments of a system; and

FIGS. 13 and 14 illustrate various embodiments of a system.

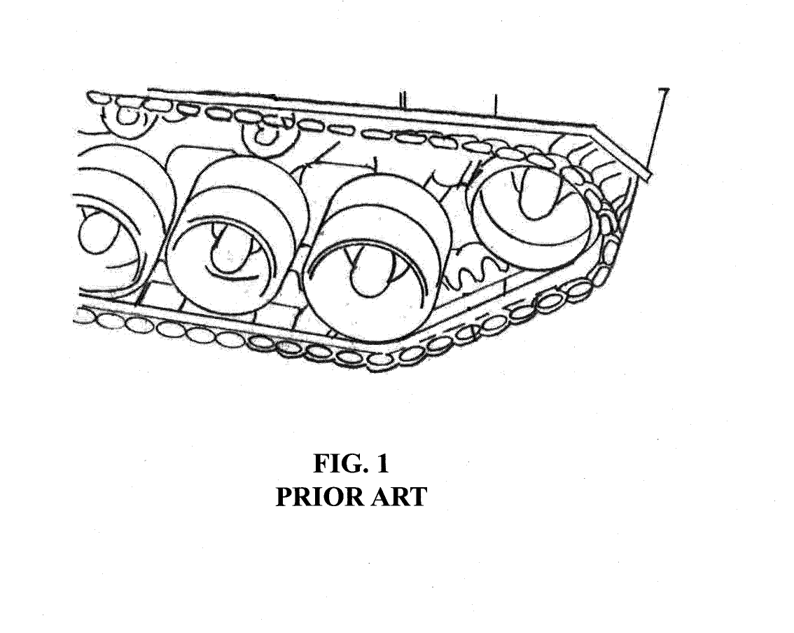

### DETAILED DESCRIPTION

In the following detailed description, reference is made to the accompanying drawings, which form a part hereof. In the drawings, similar symbols and reference characters typically identify similar components throughout the several views, unless context dictates otherwise. The illustrative embodiments described in the detailed description, drawings, and claims are not meant to be limiting. Other embodiments may be utilized, and other changes may be made, without departing from the scope of the subject matter presented here.

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Before explaining the various embodiments of the wear pad system in detail, it should be noted that the various embodiments disclosed herein are not limited in their application or use to the details of construction and arrangement of parts illustrated in the accompanying drawings and description. Rather, the disclosed embodiments may be positioned or incorporated in other embodiments, variations and modifications thereof, and may be practiced or carried out in various ways. Accordingly, embodiments of the wear pad system disclosed herein are illustrative in nature and are not meant to limit the scope or application thereof. Furthermore, unless otherwise indicated, the terms and expressions employed herein have been chosen for the purpose of describing the embodiments for the convenience of the reader and are not to limit the scope thereof. In addition, it should be understood that any one or more of the disclosed embodiments, expressions of embodiments, and/or examples thereof, can be combined with any one or more of the other disclosed embodiments, expressions of embodiments, and/or examples thereof, without limitation.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

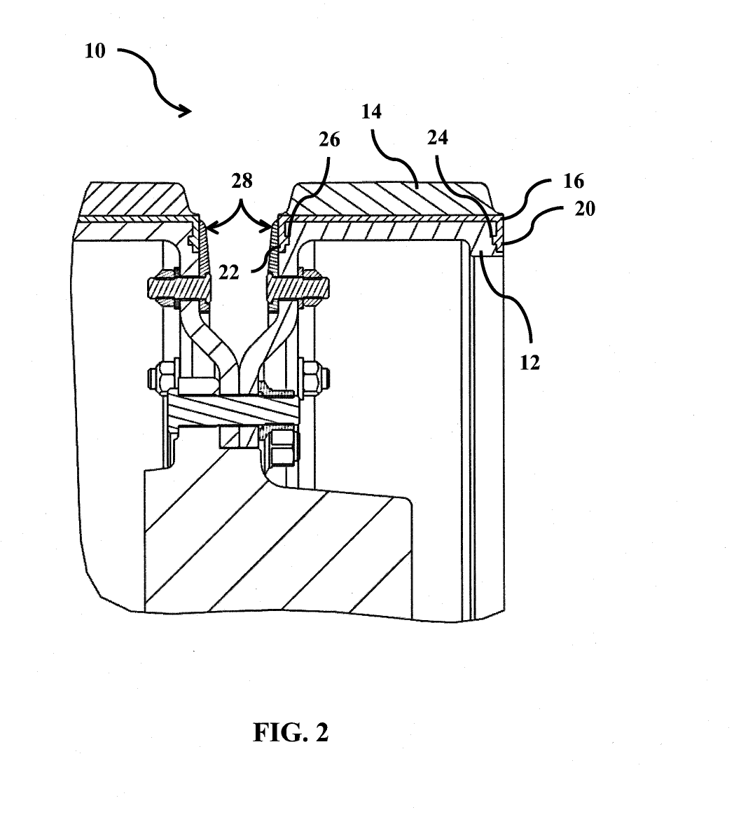

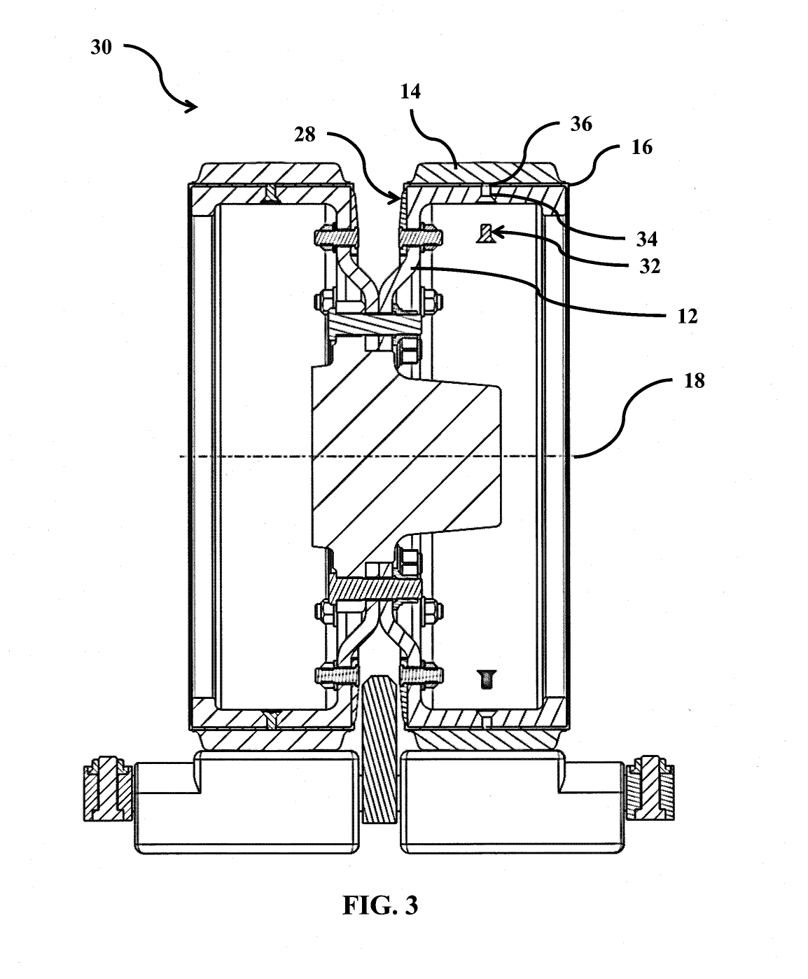

FIG. 2 illustrates various embodiments of a system 10. The system 10 includes a wheel 12, a wear pad 14 and a carrier member 16. In general, the wear pad 14 is connected to the carrier member 16 and the carrier member 16 is removably connected to the wheel 12. For purposes of simplicity, the system 10 will be described in the context of including a road wheel 12 for a tracked vehicle. However, it will be appreciated that the wheel 12 of the system 10 may be any suitable type of wheel such as, for example, a forklift wheel, a skid-steer wheel, a conveyor or belt wheel/roller, etc. The road wheel 12 rotates about an axis of rotation 18 (See, e.g., FIG. 3). Although FIG. 2 shows a single set of road wheels 12 (an inboard and an outboard road wheel) adjoined and rotating about a common axis 18, it will be appreciated that the system 10 may include any number of sets of road wheels 12. Additionally, it will also be appreciated that according to other embodiments, the road wheels 12 do not have to be configured as sets—the road wheels 12 may be configured, for example, as separate road wheels 12 which each rotate around their own axis of rotation 18.

The wear pad 14 is positioned radially outward from a circumferential portion of the road wheel 12, and is designed to protect the road wheel 12 from abrasion and thereby extend the life of the road wheel 12. The wear pad 14 may be of any suitable material. For example, according to various embodiments, the wear pad 14 may comprise a rubber, a urethane or other elastomeric material. Although it may look as though only a single wear pad 14 is shown for each road wheel 12 shown in FIG. 2, it will be appreciated that according to other embodiments, as described in more detail hereinbelow, a plurality of wear pads 14 may be utilized to cover a given road wheel 12.

The carrier member 16 may be of any suitable material. For example, according to various embodiments, the carrier member 16 may comprise a semi-flexible material such as, for example, a plastic material, a composite material, etc. The wear pad 14 (or a plurality of wear pads 14) may be connected to the carrier member 16 in any suitable manner. For example, according to various embodiments, the wear pad 14 is adhered to, bonded to, cured to, over-molded onto, etc. or otherwise fixed to the carrier member 16. The carrier member 16 may be removably connected to the road wheel 12 in any suitable manner. For example, as shown in FIG. 2, the carrier member 16 may be configured roughly in the shape of a horseshoe, with a portion 20 of the outboard side of the carrier member 16 extending axially inward and a portion 22 of the inboard side of the carrier member 16 extending axially outward. To connect the carrier member 16, and by extension the wear pad 14, to the road wheel 12, the portion 20 of the carrier member 16 is flexed axially outward and the portion 22 of the carrier member 16 is flexed axially inward. The carrier member 16 is then positioned against a circumferential portion of the road wheel 12. The flexed portions 20, 22 are then released so as to project into corresponding grooves 24, 26 defined by the road wheel 12. The resulting snap-fit connection prevents the carrier member 16, and by extension the wear pad 14, from moving radially outward from the road wheel 12, as well as from moving axially inward or outward from the road wheel 12. Although it may look as though only a single carrier member 16 is shown for each road wheel 12 shown in FIG. 2, it will be appreciated that according to other embodiments, a plurality of carrier members 16 may be utilized to cover a given road wheel 12, and each carrier member 16 may have one or more wear pads 14 connected thereto.

For the system 10 as described above, when a given wear pad 14 becomes worn or damaged, it can be easily replaced with a new wear pad 14. For example, according to various embodiments, the carrier member 16 to which the worn or damaged wear pad 14 is connected can be removed from the road wheel 12 (by flexing the portion 20 axially outward and the portion 22 axially inward to release the carrier member 16 from the corresponding grooves 24, 26) and replaced with a new carrier member 16 which has a new wear pad 14 connected thereto. The replacement can be done without special tools, without having to take the tracked vehicle to a maintenance center or depot, and without having to remove the road wheel 12 from the tracked vehicle. According to other embodiments, the worn or damaged wear pad 14 can be replaced without having to remove the carrier member 16 from the road wheel 12. For example, the worn or damaged wear pad 14 can be removed from its corresponding carrier member 16 by scraping, grinding, chiseling, etc. the worn or damaged wear pad 14 off the carrier member 16. A new wear pad 14 can then be bonded to the carrier member 16 in the location vacated by the removed wear pad 14.

As shown in FIG. 2, an optional wear ring 28 of the type known in the art may be connected to the outboard road wheel 12. The wear ring 28 may be connected to the outboard road wheel 12 in any suitable manner. For example, according to various embodiments, the wear ring 28 is bolted or otherwise fastened to the outboard road wheel 12. Although the system 10 is shown in FIG. 2 and described hereinabove in the context of the outboard road wheel 12 for purposes of simplicity, it will be appreciated that the above description of the configuration of the road wheel 12, the wear pad 14, the carrier member 16 and the optional wear ring 28 may also be applicable to the inboard road wheel (which may be the same as or different than the outboard road wheel 12).

FIG. 3 illustrates various embodiments of a system 30. The system 30 is similar to the system 10, but is different. The system 30 includes the road wheel 12, the wear pad 14 and the carrier member 16, and also includes a threaded fastener 32. As shown in FIG. 3, the system 30 may also include the optional wear ring 28. For the system 30, the road wheel 12 does not necessarily define the grooves 24, 26 and the carrier member 16 does not necessarily include the first and second portions 20, 22. Instead of being snap-fit to the road wheel 12, the carrier member 16, and by extension the wear pad 14, is secured to the road wheel by the threaded fastener 32.

The threaded fastener 32 may be any suitable type of fastener. For example, according to various embodiments, the threaded fastener 32 may be a screw or threaded bolt. To secure a given carrier member 16, and by extension a given wear pad 14, to the road wheel 12, the carrier member 16 is placed on a circumferential portion of the road wheel 12, then the threaded fastener 32 is passed radially outward through an opening 34 defined by the road wheel 12 and threaded into the carrier member 16. Thus, the threaded fastener 32 may be considered to be oriented in the radial direction. According to various embodiments, the opening 34 defined by the road wheel 12 is a threaded opening configured to threadedly engage with the threads of the threaded fastener 32. According to various embodiments, the threads of the threaded fastener 32 are threadedly engaged with a threaded receptacle 36 defined by the carrier member 16. According to other embodiments, the threaded fastener 32 is a self-tapping fastener which threads itself into the carrier member 16. According to various embodiments, the threaded fastener 32 is also threaded into the wear pad 14 or otherwise adhered to, bonded to, cured to, over-molded onto, etc. the wear pad 14. Although only two threaded fasteners 32 are shown in FIG. 3, it will be appreciated that any number of threaded fasteners 32 may be utilized to secure a given carrier member 16, and by extension one or more wear pads 14, to the road wheel 12. For embodiments utilizing more than one threaded fastener 32, it will be appreciated that each threaded fastener 32 associated with the carrier member 16 would be threadedly engaged with respective threaded receptacles 36 to secure the carrier member 16 to the wheel 12.

For the system 30 as described above, when a given wear pad 14 becomes worn or damaged, it can be easily replaced with another wear pad 14 by removing the threaded fastener 32, removing the carrier member 16 corresponding to the worn or damaged wear pad 14, positioning a replacement carrier member 16 (along with its corresponding replacement wear pad 14) in the location vacated by the removed carrier member 16, and reinstalling the threaded fastener 32 though the opening 34 defined by the road wheel 12 and into the “replacement” carrier member 16. For embodiments utilizing more than one threaded fastener 32, it will be appreciated that each threaded fastener 32 associated with the carrier member 16 would be removed and then subsequently reinstalled. The replacement can be done without special tools, without having to take the tracked vehicle to a maintenance center or depot, and without having to remove the road wheel 12 from the tracked vehicle.

Although the system 30 is shown in FIG. 3 and described hereinabove in the context of the outboard road wheel 12 for purposes of simplicity, it will be appreciated that the above description of the configuration of the road wheel 12, the wear pad 14, the carrier member 16, the threaded fastener 32 and the optional wear ring 28 may also be applicable to the inboard road wheel (which may be the same as or different than the outboard road wheel 12).

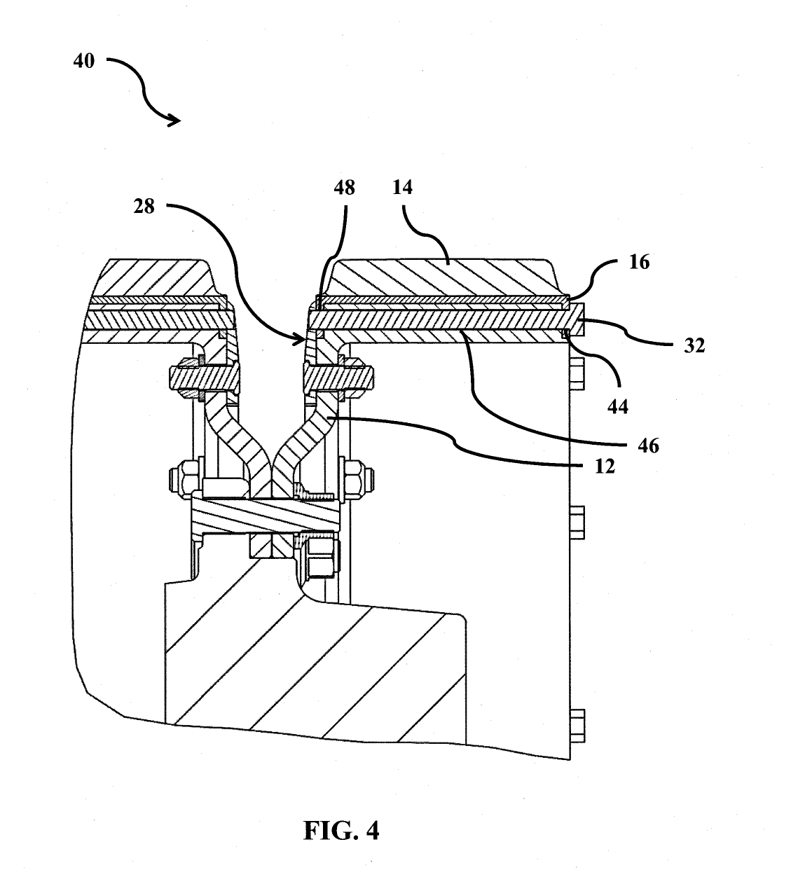

FIG. 4 illustrates various embodiments of a system 40. The system 40 is similar to the system 30, but is different. The system 40 includes the road wheel 12, the wear pad 14, the carrier member 16 and the threaded fastener 32, and in lieu of the threaded fastener 32 being oriented in a radial direction as in the system 30, the threaded fastener 32 of the system 40 is oriented in the axial direction. To secure the carrier member 16 to the road wheel 12, an end of the threaded fastener 32 is passed axially inward through an opening 44 defined by the outboard side of the carrier member 16, through an opening 46 defined by the road wheel 12, and through another opening 48 defined by the inboard side of the carrier member 16. Thus, the threaded fastener 32 of the system 40 may be considered to be oriented in the axial direction. According to various embodiments, one or more of the openings 44, 46, 48 may be threaded openings which threadedly engage with threads of the threaded fastener 32.

As shown in FIG. 4, according to various embodiments, the system 40 may also include the optional wear ring 28. Although it may look as though only a single wear ring 28 is shown for each road wheel 12, it will be appreciated that according to other embodiments, the system 40 may include a plurality of wear rings 28 for each road wheel 12. For embodiments which do not include the optional wear ring 28, when a given wear pad 14 becomes worn or damaged, it can be easily replaced with another wear pad 14 by removing the threaded fastener 32 from the carrier member 16 and the road wheel 12 in an axial outward direction, removing the carrier member 16 corresponding to the worn or damaged wear pad 14, positioning a replacement carrier member 16 (along with its corresponding replacement wear pad 14) in the location vacated by the removed carrier member 16, then reinstalling the threaded fastener 32 through the openings 44, 46, 48. For embodiments utilizing more than one threaded fastener 32, it will be appreciated that each threaded fastener 32 associated with the carrier member 16 would be removed and then subsequently reinstalled. The replacement can be done without special tools, without having to take the tracked vehicle to a maintenance center or depot, and without having to remove the road wheel 12 from the tracked vehicle.

For embodiments which include the optional wear ring 28, the wear ring 28 may be of any suitable material. For example, according to various embodiments the wear ring 28 comprises a metal material. The wear ring 28 defines an opening (not shown in FIG. 4 for purposes of simplicity) which can receive the end of the threaded fastener 32 and/or have the end of the threaded fastener 32 pass therethrough. In some embodiments, the opening defined by the wear ring 28 is a threaded opening. For the embodiments which include the optional wear ring 28, when a given wear pad 14 becomes worn or damaged, it can be easily replaced with another wear pad 14 by removing the threaded fastener 32 from the wear pad 28, the carrier member 16 and the road wheel 12 in an axial outward direction, removing the carrier member 16 corresponding to the worn or damaged wear pad 14, positioning a replacement carrier member 16 (along with its corresponding replacement wear pad 14) in the location vacated by the removed carrier member 16, then reinstalling the threaded fastener 32 through the openings 44, 46, 48 and into the opening defined by the wear member 28.

According to other embodiments, the system 40 further includes a threaded nut (not shown in FIG. 4 for purposes of simplicity). For such embodiments, the openings 44, 46, 48 (and the opening defined by the wear ring 28 as applicable) may be threaded or unthreaded openings. To connect the carrier member 16 to the road wheel 12, after an end of the threaded fastener 32 is passed through the openings 44, 46, 48 (as well as through the opening defined by the wear ring 28 as applicable), the nut is threaded onto the end of the threaded fastener 32. When a given wear pad 14 becomes worn or damaged, it can be easily replaced with another wear pad 14 by removing the nut from the threaded fastener 32, removing the threaded fastener 32 by pulling it in an axial outward direction, removing the carrier member 16 corresponding to the worn or damaged wear pad 14, positioning a replacement carrier member 16 (along with its corresponding replacement wear pad 14) in the location vacated by the removed carrier member 16, passing an end of the threaded fastener 32 back through the openings 44, 46, 48 (as well as through the opening defined by the wear ring 28 as applicable) and threading the nut onto the end of the threaded fastener 32. For embodiments utilizing more than one threaded fastener 32 (and corresponding nut), it will be appreciated that each threaded fastener 32 and corresponding nut associated with the carrier member 16 would be removed and then subsequently reinstalled. The replacement can be done without special tools, without having to take the tracked vehicle to a maintenance center or depot, and without having to remove the road wheel 12 from the tracked vehicle.

Although the system 40 is shown in FIG. 4 and described hereinabove in the context of the outboard road wheel 12 for purposes of simplicity, it will be appreciated that the above description of the configuration of the wear pad 14, the carrier member 16, the threaded fastener 32, the optional wear pad 28 and the optional threaded nut may also be applicable to the inboard road wheel (which may be the same as or different than the outboard road wheel 12).

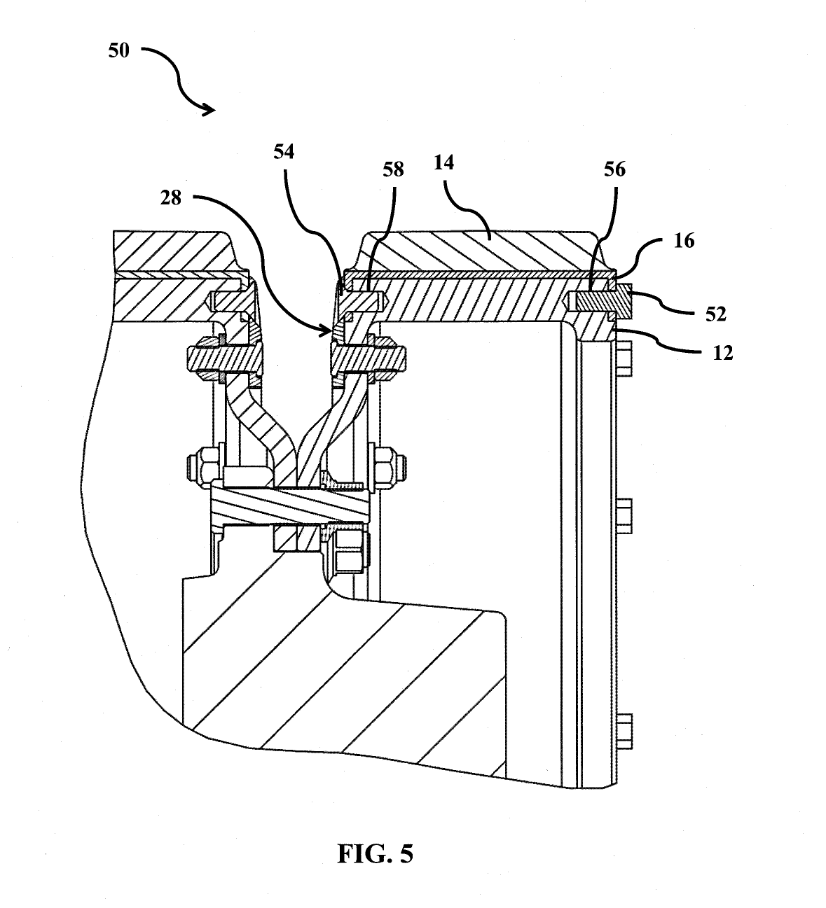

FIG. 5 illustrates various embodiments of a system 50. The system 50 is similar to the system 40, but is different. The system 50 includes the road wheel 12, the wear pad 14 and the carrier member 16, and also includes a first threaded fastener 52 and a second threaded fastener 54. The first and second threaded fasteners 52, 54 may be similar to the threaded fastener 32, but are shorter in length. In addition, the road wheel 12 defines a first threaded receptacle 56 and a second threaded receptacle 58.

For the embodiments shown in FIG. 5, the carrier member 16 is removably connected to the road wheel 12 with the first and second threaded fasteners 52, 54. An end of the first threaded fastener 52 is passed axially inward through an opening 44 defined by the outboard side of the carrier member 16, and is threadedly engaged with the first threaded receptacle 56. Similarly, an end of the second threaded fastener 54 is passed axially outward through an opening 48 defined by the inboard side of the carrier member 16, and is threadedly engaged with the second threaded receptacle 58. The first and second threaded fasteners 52, 54 cooperate to secure the carrier member 16, and by extension the wear pad 14, to the road wheel 12. According to various embodiments, the openings 44, 48 defined by the carrier member 16 may be threaded openings which threadedly engage with threads of the first and second threaded fasteners 52, 54. For embodiments which include the optional wear ring 28, the second threaded fastener 54 can also pass through the opening defined by the wear ring 28.

Although only one first threaded fastener 52 and one second threaded fastener 54 are shown in FIG. 5, it will be appreciated that any number of first and second threaded fasteners 52, 54 may be utilized to secure a given carrier member 16, and by extension one or more wear pads 14, to the road wheel 12. For embodiments utilizing more than one first threaded fastener 52 and corresponding second threaded fastener 54, it will be appreciated that each first threaded fastener 52 and each second threaded fastener 54 associated with the carrier member 16 would be threadedly engaged with respective first and second threaded receptacles 56, 58 to secure the carrier member 16 to the road wheel 12.

For the system 50 as described above, when a given wear pad 14 becomes worn or damaged, it can be easily replaced with another wear pad 14 by removing the first and second fasteners 52, 54, removing the carrier member 16 corresponding to the worn or damaged wear pad 14, positioning a replacement carrier member 16 (along with its corresponding replacement wear pad 14) in the location vacated by the removed carrier member 16, and reinstalling the first and second fasteners 52, 54 as described hereinabove. For embodiments utilizing more than one first fastener 52 and corresponding second fastener 52, it will be appreciated that each first and second fastener 52, 54 associated with the carrier member 16 would be removed and then subsequently reinstalled. The replacement can be done without special tools, without having to take the tracked vehicle to a maintenance center or depot, and without having to remove the road wheel 12 from the tracked vehicle.

Also, although the system 50 is shown in FIG. 5 and is described hereinabove in the context of the outboard road wheel 12 for purposes of simplicity, it will be appreciated that the above description of the configuration of the wear pad 14, the carrier member 16, and the first and second threaded fasteners 52, 54 may also be applicable to the inboard road wheel (which may be the same as or different than the outboard road wheel 12).

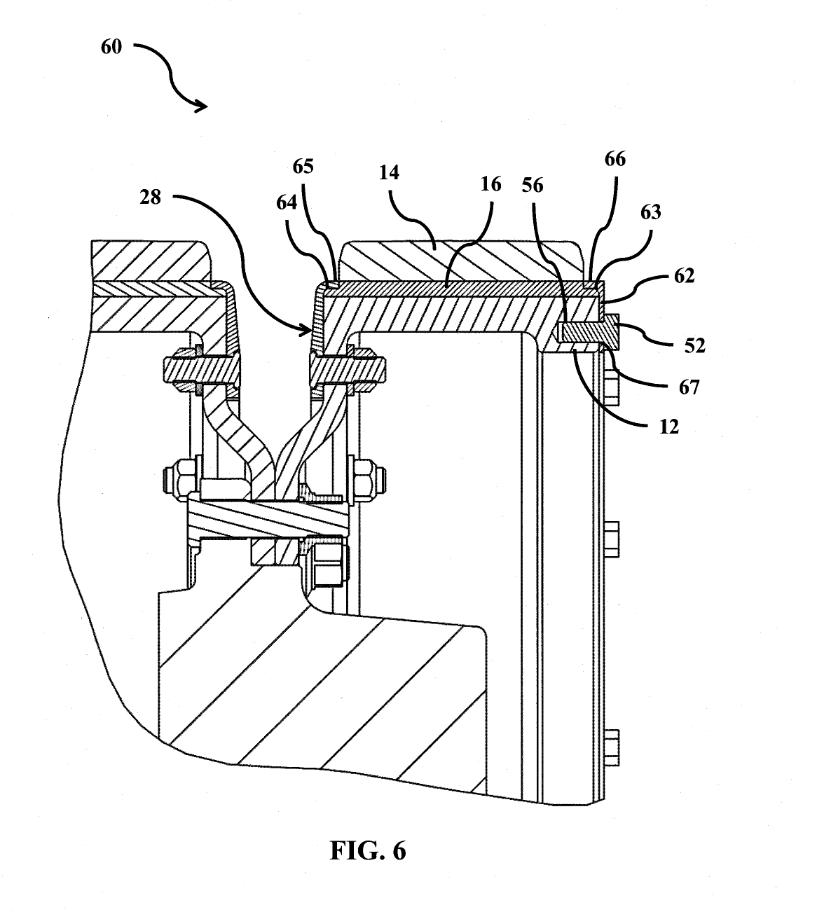

FIG. 6 illustrates various embodiments of a system 60. The system 60 is similar to the system 50, but is different. The system 60 includes the road wheel 12, the wear pad 14, the carrier member 16, the wear ring 28, the threaded fastener 52 and the threaded receptacle 56, and also includes a lock ring 62. For these embodiments, the outboard side of the carrier member 16 includes a first foot portion 63 which extends axially outward, the inboard side of the carrier member 16 includes a second foot portion 64 which extends axially inward, and the carrier member 16, and by extension the wear pad 14 connected thereto, is removably connected to the road wheel 12 by the wear ring 28 and the lock ring 62.

As shown in FIG. 6, the wear ring 28 includes a leg 65 which extends axially outward and covers “over” the second foot portion 64 of the carrier member 16 (the leg 65 is radially outward from second foot portion 64). Although the wear ring 28 is shown as being connected to the road wheel 12 by a nut and bolt, it will be appreciated that the wear ring 28 may be connected to the road wheel 12 in any suitable manner. The lock ring 62 includes a leg 66 which extends axially inward and covers “over” the first foot portion 63 of the carrier member 16 (the leg 66 is radially outward from the first foot portion 63). The lock ring 62 defines an opening 67 therethrough and is connected to the road wheel 12 by the threaded fastener 52, which passes through the opening 67 and is engaged by the threaded receptacle 56. According to various embodiments, the opening 67 is a threaded opening. Collectively, the wear ring 28 and the lock ring 62 cooperate to keep the carrier member 16 from moving axially, and the respective legs 65, 66 cooperate to keep the carrier member 16 from moving radially outward.

Although only one wear ring 28 and one lock ring 62 are shown in FIG. 6, it will be appreciated that the system 60 may include any number of wear rings 28 and lock rings 62. Also, although only one nut/bolt pair is shown as securing the wear ring 28 to the road wheel 12, it will be appreciated that any number of nut/bolt pairs may be utilized to secure a given wear ring 28 to the road wheel 12. Similarly, although only one threaded fastener 52 is shown as securing the lock ring 62 to the road wheel 12, it will be appreciated that any number of threaded fasteners 52 may be utilized to secure a given lock ring 62 to the road wheel 12.

For the system 60 as described above, when a given wear pad 14 becomes worn or damaged, it can be easily replaced with another wear pad 14 by removing the threaded fastener 52 and removing the lock ring 62, removing the carrier member 16 corresponding to the worn or damaged wear pad 14 by moving the carrier member 16 axially outward, moving a replacement carrier member 16 (along with its corresponding replacement wear pad 14) axially inward until it is in the location vacated by the removed carrier member 16 (in this position the second foot portion 64 is “under” the leg 65), placing the lock ring 62 in its previous position (in this position the first foot portion 63 is “under” the leg 66), and reinstalling the threaded fastener 52. For embodiments utilizing more than one threaded fastener 52, it will be appreciated that each threaded fastener 52 associated with the lock ring 62 would be removed and then subsequently reinstalled. The replacement can be done without special tools, without having to remove the wear ring 28, without having to take the tracked vehicle to a maintenance center or depot, and without having to remove the road wheel 12 from the tracked vehicle.

Also, although the system 60 is shown in FIG. 6 and is described hereinabove in the context of the outboard road wheel 12 for purposes of simplicity, it will be appreciated that the above description of the configuration of the carrier member 16, the wear ring 28 and the lock ring 62 may also be applicable to the inboard road wheel (which may be the same as or different than the outboard road wheel 12).

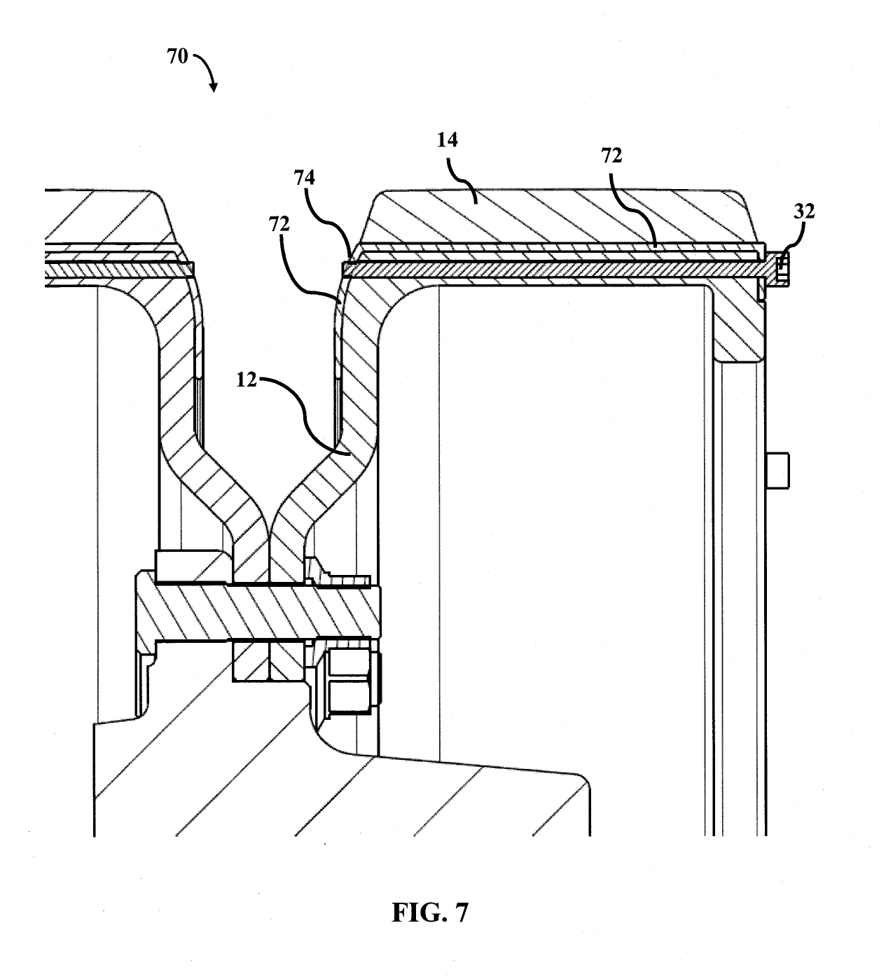

FIG. 7 illustrates various embodiments of a system 70. The system 70 is similar to the system 40, but is different. The system 70 includes a road wheel 12, a wear pad 14 and a threaded fastener 32, and also includes a wear ring member 72 which combines the functionality of the wear ring 28 and the carrier member 16 into a single component. The wear ring member 72 may be considered an integrated wear ring/carrier member (or an integrated carrier member/wear ring), and comprises a material having a suitable wear surface. For example, according to various embodiments, the wear ring member 72 comprises a metal material (e.g., a steel material). The wear ring member 72 defines an opening or receptacle 74. According to various embodiments, the opening 74 can be a threaded opening or a threaded receptacle configured to threadedly engage with the threads of an end of the threaded fastener 32. The wear pad 14 may be connected to the wear ring member 72 in any suitable manner. For example, according to various embodiments, the wear pad 14 may be connected to the wear ring member 72 in the same manner as the wear pad 14 is connected to the carrier member 16 as described hereinabove.

For embodiments where the opening 74 is threaded, to secure the wear ring member 72 to the road wheel 12, an end of the threaded fastener 32 is passed axially inward through an opening 44 (now defined by an axially outboard end of the wear ring member 72), through an opening 46 defined by the road wheel 12 and is then threadedly engaged with the threaded receptacle 74 defined by the wear ring member 72. As described hereinabove, the openings 44, 46 can be threaded openings. For embodiments utilizing more than one threaded fastener 32, it will be appreciated that each threaded fastener 32 associated with the wear ring member 72 would be threadedly engaged with respective threaded receptacles 74 to secure the wear ring member 72 to the road wheel 12.

For the system 70 as described above, when a given wear pad 14 becomes worn or damaged, it can be easily replaced with another wear pad 14 by removing the threaded fastener 32, removing the wear ring member 72 corresponding to the worn or damaged wear pad 14, positioning a replacement wear ring member 72 (along with its corresponding replacement wear pad 14) in the location vacated by the removed wear ring member 72, and reinstalling the threaded fastener 32 as described hereinabove. For embodiments utilizing more than one threaded fastener 32, it will be appreciated that each threaded fastener 32 associated with the wear ring member 72 would be removed and then subsequently reinstalled. The replacement can be done without special tools, without having to take the tracked vehicle to a maintenance center or depot, and without having to remove the road wheel 12 from the tracked vehicle.

According to other embodiments, the system 70 further includes a threaded nut (not shown in FIG. 7 for purposes of simplicity). For such embodiments, the openings 44, 46, 74 may be threaded or unthreaded openings. To connect the wear ring member 72 to the road wheel 12, after an end of the threaded fastener 32 is passed through the openings 44, 46, 74, the nut is threaded onto the end of the threaded fastener 32. When a given wear pad 14 becomes worn or damaged, it can be easily replaced with another wear pad 14 by removing the nut from the threaded fastener 32, removing the threaded fastener 32 by pulling it in an axial outward direction, removing the wear ring member 72 corresponding to the worn or damaged wear pad 14, positioning a replacement wear ring member 72 (along with its corresponding replacement wear pad 14) in the location vacated by the removed wear ring member 72, passing an end of the threaded fastener 32 back through the openings 44, 46, 74 and threading the nut onto the end of the threaded fastener 32. For embodiments utilizing more than one threaded fastener 32 (and corresponding nut), it will be appreciated that each threaded fastener 32 and corresponding nut associated with the carrier member 16 would be removed and then subsequently reinstalled. The replacement can be done without special tools, without having to take the tracked vehicle to a maintenance center or depot, and without having to remove the road wheel 12 from the tracked vehicle.

Although only a single wear ring member 72 is shown for the outboard road wheel 12 in FIG. 7, it will be appreciated that according to other embodiments, each road wheel 12 may have a plurality of wear ring members 72 (e.g., one segmented wear ring member 72 for each wear pad 14) connected thereto. Also, although the system 70 is shown in FIG. 7 and is described hereinabove in the context of the outboard road wheel 12 for purposes of simplicity, it will be appreciated that the above description of the configuration of the wear pad 14, the threaded fastener 32 and the wear ring member 72 may also be applicable to the inboard road wheel (which may be the same as or different than the outboard road wheel 12).

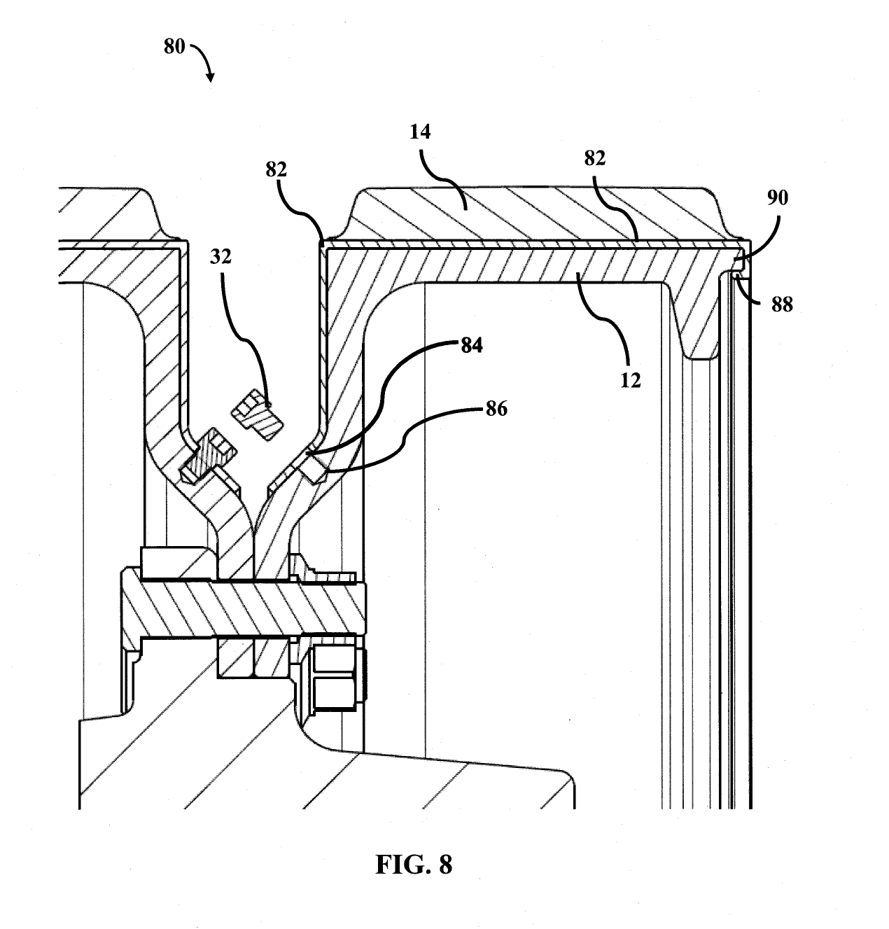

FIG. 8 illustrates various embodiments of a system 80. The system 80 is similar to the system 70, but is different. The system 80 includes a road wheel 12, a wear pad 14 a threaded fastener 32, and also includes a wear ring member 82 which is similar to the wear ring member 72 in that it also combines the functionality of the wear ring 28 and the carrier member 16 into a single component. The inboard side of the wear ring member 82 defines an opening 84 therethough, and the inboard side of the road wheel 12 defines a threaded receptacle 86 which is configured to threadedly engage with the threads of an end of the threaded fastener 32. According to various embodiments, the opening 84 is a threaded opening configured to threadedly engage the threads of an end of the threaded fastener 32.

As shown in FIG. 8, at the inboard side of the outboard road wheel 12, the wear ring member 82 is connected to the road wheel 12 with a threaded fastener 32 which passes through the opening 84 and is threadedly engaged with the threaded receptacle 86. At the outboard side of the outboard road wheel 12, the wear ring member 82 includes a return leg 88 which snaps over a portion 90 of the outboard side of the road wheel 12. The threaded fastener 32 and the above-described snap-fit connection between the ring wear member 82 and the outboard side of the road wheel 12 cooperate to keep the wear ring member 82 in the desired position relative to the road wheel 12.

To secure the wear ring member 82 to the road wheel 12, the return leg 88 on the outboard side of the wear ring member 82 is positioned “under” (radially inward from) the portion 90 of the road wheel 12 and pushed axially inward until it is secured against the outboard side of the road wheel 12. The inboard side of the wear ring member 82 may then be pushed substantially radially inward until the inboard side of the wear ring member 82 is positioned against the inboard side of the road wheel 12. The threaded fastener 32 is then passed substantially radially inward through the opening 84 defined by the inboard side of the wear ring member 82 and is then threadedly engaged with the threaded receptacle 86 defined by the road wheel 12. For embodiments utilizing more than one threaded fastener 32, it will be appreciated that each threaded fastener 32 associated with the wear ring member 82 would be threadedly engaged with respective threaded receptacles 86 to secure the wear ring member 82 to the wheel 12.

For the system 80 as described above, when a given wear pad 14 becomes worn or damaged, it can be easily replaced with another wear pad 14 by removing the threaded fastener 32, removing the wear ring member 82 corresponding to the worn or damaged wear pad 14 (by pushing or pulling the inboard side of the wear ring member 82 substantially radially outward, then pushing or pulling the return leg 88 axially outward from the road wheel 12), positioning a replacement wear ring member 82 (along with its corresponding replacement wear pad 14) in the location vacated by the removed wear ring member 82, and installing the replacement wear ring member 82 as described hereinabove. For embodiments utilizing more than one threaded fastener 32, it will be appreciated that each threaded fastener 32 associated with the wear ring member 82 would be removed and then subsequently reinstalled. The replacement can be done without special tools, without having to take the tracked vehicle to a maintenance center or depot, and without having to remove the road wheel 12 from the tracked vehicle.

Although only a single threaded fastener 32 and a single return leg 88 are shown for the outboard road wheel 12 in FIG. 8, it will be appreciated that according to other embodiments, each wear ring member 82 may utilize a plurality of threaded fasteners 32 and/or a plurality of return legs 88 to secure the wear ring member 82 to the road wheel 12. Also, although the system 80 is shown in FIG. 8 and is described hereinabove in the context of the outboard road wheel 12 for purposes of simplicity, it will be appreciated that the above description of the configuration of the road wheel 12, the wear pad 14, the threaded fastener 32 and the wear ring member 82 may also be applicable to the inboard road wheel (which may be the same as or different than the outboard road wheel 12).

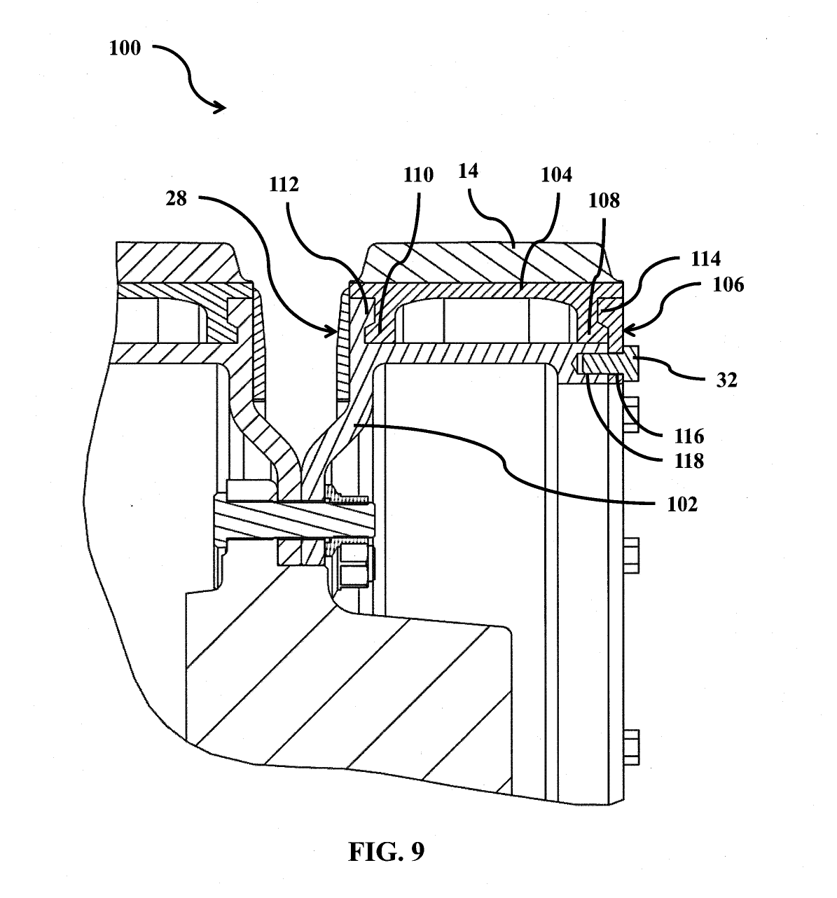

FIG. 9 illustrates various embodiments of a system 100. The system 100 is similar to the systems shown in FIGS. 2-8, but is different. The system 100 includes a wear pad 14 and a threaded fastener 32, and also includes a road wheel 102, a carrier member 104 and a lock ring member 106. The road wheel 102 is configured differently than the road wheels shown in FIGS. 2-8, and the carrier member 104 is also configured differently than the carrier members shown in FIGS. 2-8. The outboard side of the carrier member 104 includes a first foot portion 108 which extends axially outward, and the inboard side of the carrier member 104 includes a second foot portion 110 which extends axially inward. The lock ring member 106 may be of any suitable material. For example, according to various embodiments, the lock ring member 106 comprises a metal material (e.g., a steel material). Although only one lock ring member 106 is shown for the outboard wheel 102 in FIG. 9, it will be appreciated that according to various embodiments, each road wheel 102 may include a plurality of lock ring members 106 (e.g., one segmented lock ring member 106 for each carrier member 104) connected thereto.

To secure the carrier member 104, and by extension the wear pad 14, to the road wheel 102, the carrier member 104 is placed on the road wheel 102 with the second foot portion 100 being positioned “under” (radially inward from) a portion 112 of the inboard side of the road wheel 102 which extends axially outward. At the outboard side of the road wheel 102, the lock ring member 106 is positioned against the outboard side of the road wheel 102 and against the first foot portion 108. The lock ring member 106 includes a portion 114 which extends axially inward and is positioned “over” (radially outward from) the first foot portion 108. The threaded fastener 32 is passed axially inward through an opening 116 defined by the lock ring member 106 and is threadedly engaged with a threaded receptacle 118 defined by the road wheel 102. According to various embodiments, the opening 116 defined by the lock ring member 106 is a threaded opening. The road wheel 102 and the lock ring member 106 cooperate to keep the carrier member 104 from moving axially, and the overlap of the first and second foot portions 108, 110 by the portion 114 of the lock ring member 106 and the portion 112 of the road wheel 102 cooperate to keep the carrier member 104 from moving radially. For embodiments utilizing more than one threaded fastener 32, it will be appreciated that each threaded fastener 32 associated with the lock ring member 106 would be threadedly engaged with respective threaded receptacles 118 to secure the lock ring member 106 to the wheel 102.

For the system 100 as described above, when a given wear pad 14 becomes worn or damaged, it can be easily replaced with another wear pad 14 by removing the threaded fastener 32, removing the lock ring member 106, removing the carrier member 104 corresponding to the worn or damaged wear pad 14 (by pushing or pulling the outboard side of the carrier member axially outward), positioning a replacement carrier member 104 (along with its corresponding replacement wear pad 14) in the location vacated by the removed carrier member 104, and installing the lock ring member 106 and the threaded fastener 32 as described hereinabove. For embodiments utilizing more than one threaded fastener 32, it will be appreciated that each threaded fastener 32 associated with the lock ring member 106 would be removed and then subsequently reinstalled. The replacement can be done without special tools, without having to take the tracked vehicle to a maintenance center or depot, and without having to remove the road wheel 12 from the tracked vehicle.

Although only one wear pad 14, one threaded fastener 32, one carrier member 104 and one lock ring member 106 are shown for the outboard road wheel 102 in FIG. 9, it will be appreciated that according to other embodiments, the system 100 may include a plurality of such components. Also, although the system 100 is shown in FIG. 9 and is described hereinabove in the context of the outboard road wheel 102 for purposes of simplicity, it will be appreciated that the above description of the wear pad 14, the threaded fastener 32, the carrier member 104 and the lock ring member 106 may also be applicable to the inboard road wheel (which may be the same as or different than the outboard road wheel 102).

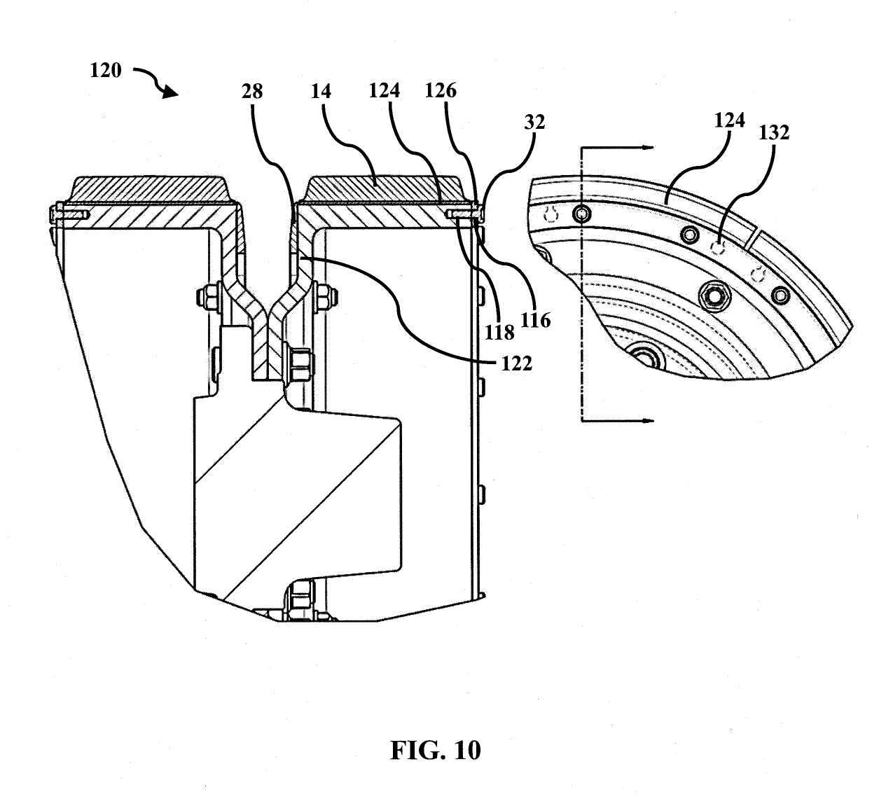

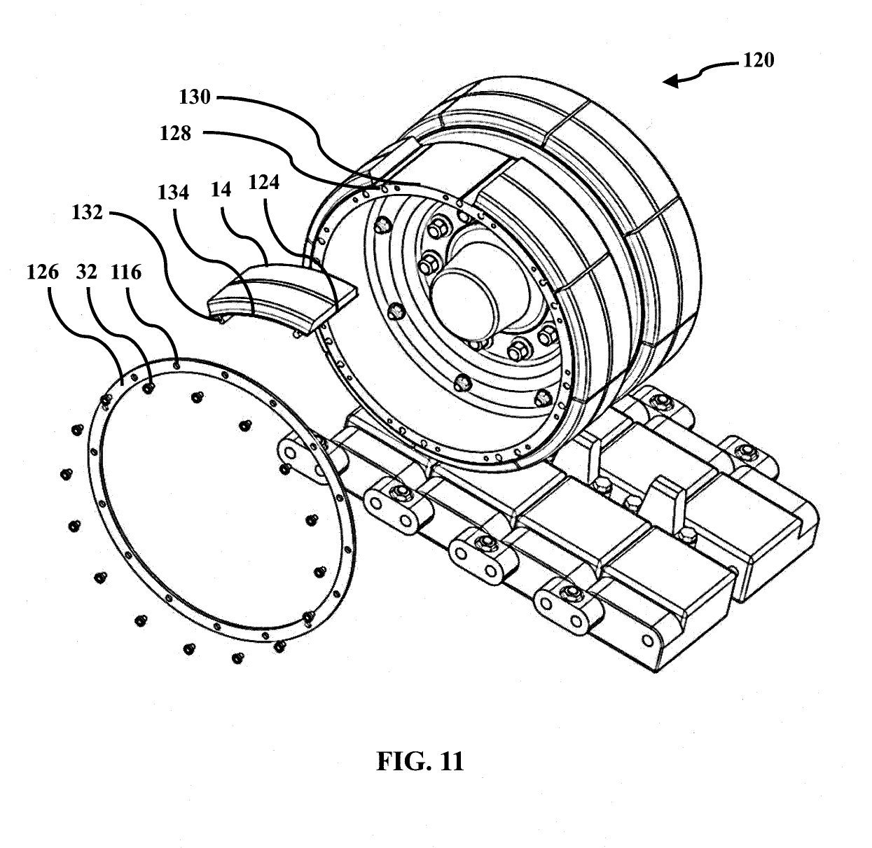

FIGS. 10 and 11 illustrate various embodiments of a system 120. In FIG. 10, the right hand portion of the figure is a side view of the system 120. The system 120 is similar to the systems of FIGS. 2-9, but is different. The system 120 includes a wear pad 14 and a threaded fastener 32, and also includes a road wheel 122, a carrier member 124 and a lock ring member 126. The road wheel 122 is configured differently than the road wheels shown in FIGS. 2-9, the carrier member 124 is configured differently than the carrier members shown in FIGS. 2-6 and 9 (as well as the wear ring members 72, 82 shown in FIGS. 7 and 8), and the lock ring member 126 is configured differently than the lock ring member 106 shown in FIG. 9.

The road wheel 122 defines a plurality of axial grooves 128 (See FIG. 11) which extend radially inward from a portion 130 (e.g., a radially outward circumferential surface) of the road wheel 122. The carrier member 124 includes projections 132 (See FIG. 11) which extend radially inward from a portion 134 (e.g., a radially inward circumferential surface) of the carrier member 124. The projections 132 are configured to be received and captured by the axial grooves 128. The axial grooves 128 may thus be considered to be captive grooves. It will be appreciated that the axial grooves 128 and the projections 132 may be of any suitable size and shape. For example, according to various embodiments, the axial grooves 128 and the corresponding projections 132 may be in the shape of a t-slot, a dove-tail, a key-hole, and I-shape, etc., with the projections 132 being slightly smaller than the axial grooves 128 so as to be able to fit snugly within the axial grooves 128. The lock ring member 126 is similar to the lock ring member 106, but does not necessarily include the portion 114 of the lock ring member 106.

To secure the carrier member 124, and by extension the wear pad 14, to the road wheel 122, the carrier member 124 is positioned at the outboard side of the road wheel 102, its projections 132 are aligned with the axial grooves 128, and the carrier member 124 is pushed axially inward until the inboard side of the carrier member 124 is against a portion 136 of the inboard side of the road wheel 122. The lock ring member 126 is then positioned against the outboard side of the road wheel 122 and the outboard side of the carrier member 124, then an end of the threaded fastener 32 is passed axially inward through an opening 116 defined by the lock ring member 126 and is threadedly engaged with a threaded receptacle 118 defined by the road wheel 122. According to various embodiments, the opening 116 defined by the lock ring member 126 may be a threaded opening. For embodiments utilizing more than one threaded fastener 32, it will be appreciated that each threaded fastener 32 associated with the lock ring member 126 would be threadedly engaged with respective threaded receptacles 118 to secure the lock ring member 126 to the wheel 122.

For the system 120 as described above, when a given wear pad 14 becomes worn or damaged, it can be easily replaced with another wear pad 14 by removing the threaded fastener 32, removing the lock ring member 126, removing the carrier member 124 corresponding to the worn or damaged wear pad 14 (by pulling the carrier member 124 axially outward), positioning a replacement carrier member 124 (along with its corresponding replacement wear pad 14) in the location vacated by the removed carrier member 124, and installing the lock ring member 126 and the threaded fastener 32 as described hereinabove. For embodiments utilizing more than one threaded fastener 32, it will be appreciated that each threaded fastener 32 associated with the lock ring member 126 would be removed and then subsequently reinstalled. The replacement can be done without special tools, without having to take the tracked vehicle to a maintenance center or depot, and without having to remove the road wheel 12 from the tracked vehicle.

Although only two projections 132 are shown for each carrier member 124 in FIGS. 10 and 11, it will be appreciated that according to other embodiments, a given carrier member 124 may include any number of projections 132, and some of such projections 132 may be of a different shape than other of the projections 132. Also, although only one lock ring member 126 is shown in FIGS. 10 and 11, it will be appreciated that the system 120 may include a plurality of lock ring members 126 (e.g., one segmented lock ring member 126 for each carrier member 124). Additionally, although the system 120 is shown in FIGS. 10 and 11 and is described hereinabove in the context of the outboard road wheel 122 for purposes of simplicity, it will be appreciated that the above description of the road wheel 122, the wear pad 14, the threaded fastener 32, the carrier member 124 and the lock ring member 126 may also be applicable to the inboard road wheel (which may be the same as or different than the outboard road wheel 122).

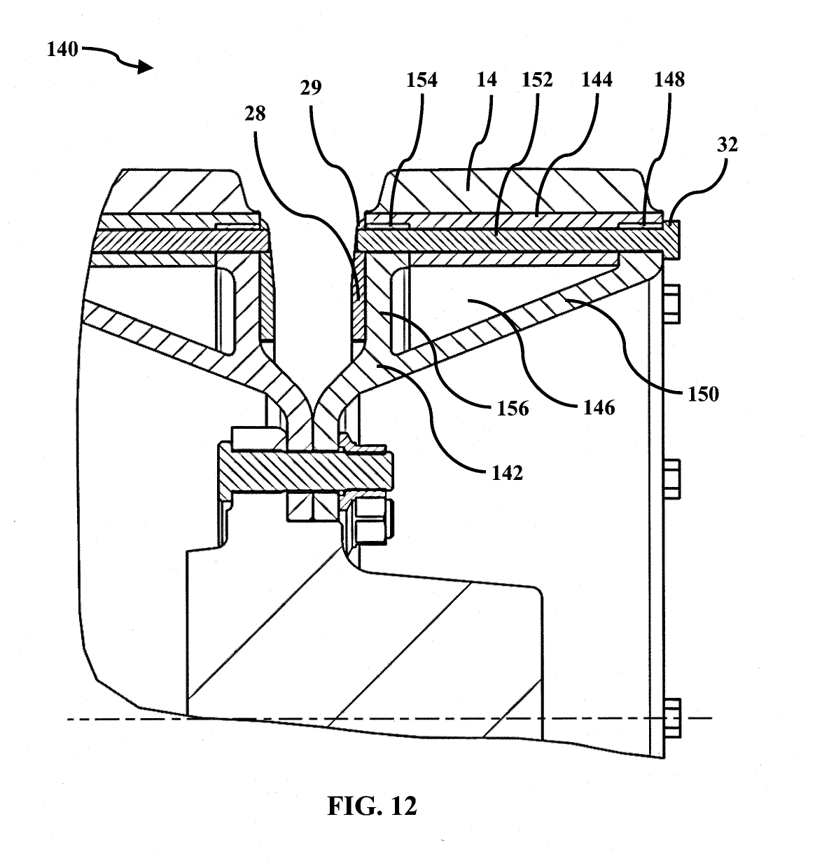

FIG. 12 illustrates various embodiments of a system 140. The system 140 is similar to the systems of FIGS. 2-11, but is different. The system 100 includes a wear pad 14 and a threaded fastener 32, and also includes a road wheel 142 and a carrier member 144. The road wheel 142 is configured differently than the road wheels shown in FIGS. 2-11 and the carrier member 144 is also different than the carrier members shown in FIGS. 2-11. The system 140 also includes a wear ring 28 which defines an opening or receptacle 29. According to various embodiments, the opening or receptacle 29 is a threaded opening/receptacle which can threadingly engage with the threads of the threaded fastener 32 to secure the carrier member 144 to the road wheel 142.

As shown in FIG. 12, the carrier member 144 is a structural member which spans an open-area 146 defined by the road wheel 142 and thus carries part of the load carried by the road wheels of FIGS. 2-11. The carrier member 144 may be of any suitable material. For example, according to various embodiments, the carrier member 144 may comprise a metal material, a composite material, etc. To secure the carrier member 144, and by extension the wear pad 14, to the road wheel 142, an end of the threaded fastener 32 is passed axially inward through an opening 148 defined by an outboard portion 150 of the road wheel 142, through an opening 152 defined by the carrier member 144, through another opening 154 defined by an inboard portion 156 of the road wheel 142 and is threadedly engaged with the threaded opening/receptacle 29 of the wear ring 28. Each of the openings 148, 152, 154 may be threaded or unthreaded openings. For embodiments utilizing more than one threaded fastener 32, it will be appreciated that each threaded fastener 32 associated with the carrier member 144 would be threadedly engaged with respective threaded openings/receptacles 29 to secure the carrier member 144 to the road wheel 142.

For the system 140 as described above, when a given wear pad 14 becomes worn or damaged, it can be easily replaced with another wear pad 14 by removing the threaded fastener 32, removing the carrier member 144 corresponding to the worn or damaged wear pad 14 (by pushing or pulling the carrier member 144 radially outward from the road wheel 142), positioning a replacement carrier member 144 (along with its corresponding replacement wear pad 14) in the location vacated by the removed carrier member 144, and installing the threaded fastener 32 as described hereinabove. For embodiments utilizing more than one threaded fastener 32, it will be appreciated that each threaded fastener 32 associated with the carrier member 144 would be removed and then subsequently reinstalled. The replacement can be done without special tools, without having to take the tracked vehicle to a maintenance center or depot, and without having to remove the road wheel 12 from the tracked vehicle.

According to other embodiments, the system 140 further includes a threaded nut (not shown in FIG. 12 for purposes of simplicity). For such embodiments, the openings 148, 152, 154, 29 may be threaded or unthreaded openings. To connect the carrier member 144 to the road wheel 142, after an end of the threaded fastener 32 is passed through the openings 148, 152, 154, 29, the nut is threaded onto the end of the threaded fastener 32. When a given wear pad 14 becomes worn or damaged, it can be easily replaced with another wear pad 14 by removing the nut from the threaded fastener 32, removing the threaded fastener 32 by pulling it in an axial outward direction, removing the carrier member 144 corresponding to the worn or damaged wear pad 14, positioning a replacement carrier member 144 (along with its corresponding replacement wear pad 14) in the location vacated by the removed carrier member 144, passing an end of the fastener 32 back through the openings 148, 152, 154, 29 and threading the nut onto the end of the threaded fastener 32. For embodiments utilizing more than one threaded fastener 32 (and corresponding nut), it will be appreciated that each threaded fastener 32 and corresponding nut associated with the carrier member 16 would be removed and then subsequently reinstalled. The replacement can be done without special tools, without having to take the tracked vehicle to a maintenance center or depot, and without having to remove the road wheel 12 from the tracked vehicle.

Although only one wear pad 14, one threaded fastener 32, one wear ring 28 and one carrier member 144 are shown for the outboard road wheel 142 in FIG. 12, it will be appreciated that according to other embodiments, the system 140 may include a plurality of such components. Also, although the system 140 is shown in FIG. 12 and is described hereinabove in the context of the outboard road wheel 142 for purposes of simplicity, it will be appreciated that the above description of the road wheel 142, the carrier member 144 and the other components may also be applicable to the inboard road wheel (which may be the same as or different than the outboard road wheel 142).

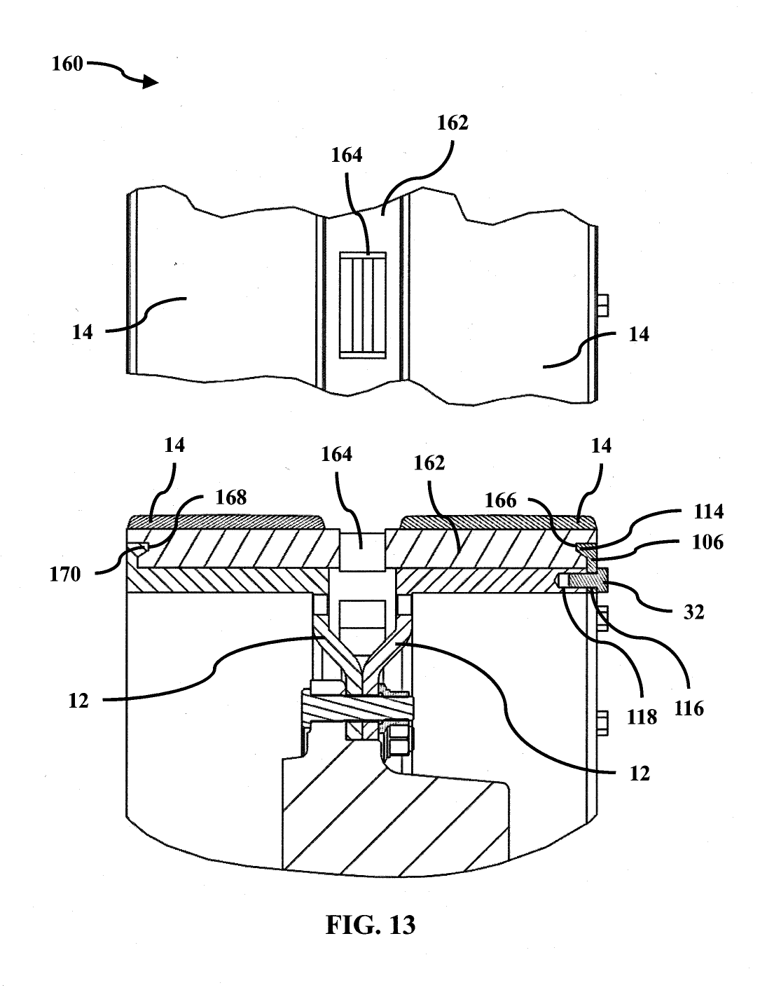

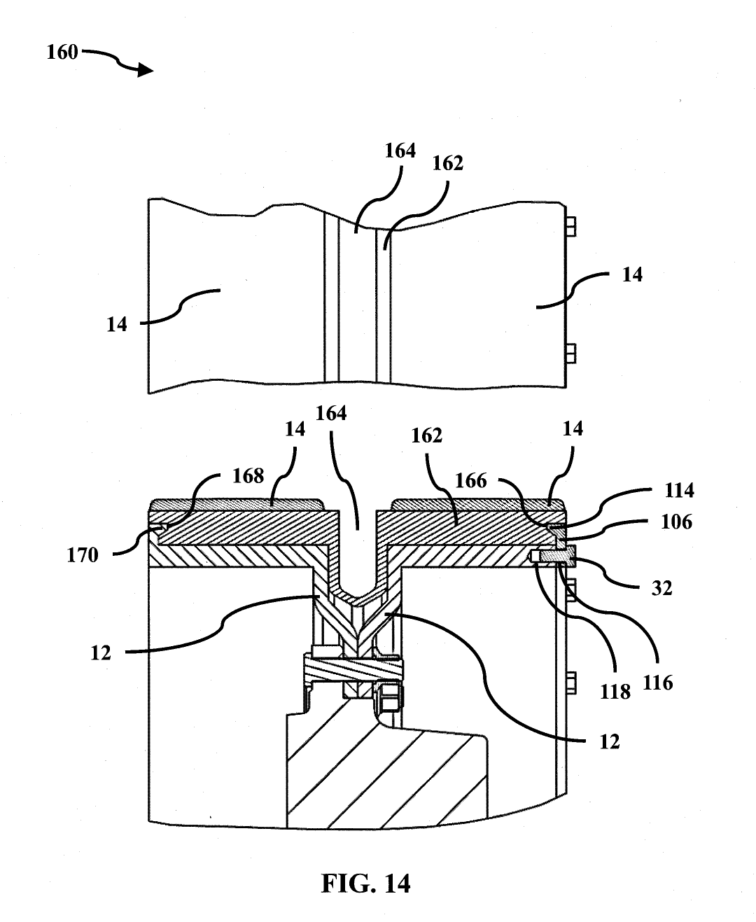

FIGS. 13 and 14 illustrate various embodiments of a system 160. Whereas the systems shown in FIGS. 2-12 are for individual road wheels 12, the system 160 may be utilized for a set of road wheels 12 (an inboard road wheel 12 and an outboard road wheel 12) adjoined and rotating about a common axis 18. In other words, the inboard and outboard road wheels 12 are axially aligned. In each of FIGS. 13-14, the lower portion of each figure is a cross-section of the system 160 and the upper portion is a top view of the cross-section. The system 160 includes a carrier member 162 which is spans the set of road wheels 12 and is connected to the set of road wheels 12 and to at least two wear pads 14 (e.g., at least one wear pad for each road wheel 12). At least one of the wear pads 14 is radially aligned with the outboard road wheel 12 and at least one of the wear pads 14 is radially aligned with the inboard road wheel 12. The carrier member 162 also defines an opening 164 positioned between the set of road wheels 12 and configured to provide sufficient clearance for a track tooth (a center guide) of the track of the tracked vehicle. As shown in FIG. 14, according to various embodiments, the carrier member 162 may be of a profile which clears the track tooth in any position, thereby effectively preventing the need to synchronize the track teeth with the opening 164. The outboard side of the carrier member 162 includes a first recess 166 and the inboard side of the carrier member 162 includes a second recess 168. The system 160 also includes the lock ring member 106 and the threaded fastener 32.

To secure the carrier member 162, and by extension the wear pads 14, to the inboard and outboard road wheels 12, the carrier member 162 is positioned at the outboard side of the outboard road wheel 12, then slid axially inward until the recess 168 of the carrier member 162 is engaged with an axially outward projecting portion 170 of the inboard side of the inboard road wheel 12. The lock ring member 106 is then positioned against the outboard side of the outboard road wheel 12 and against the outboard side of the carrier member 162 in a manner which engages the portion 114 of the lock ring member 106 with the recess 166 of the carrier member 162. An end of the threaded fastener 32 is then passed axially inward through an opening 116 defined by the lock ring member 166 and is threadedly engaged with a threaded receptacle 118 defined by the outboard road wheel 12. According to various embodiments, the opening 116 defined by the lock ring member 106 may be a threaded opening. For embodiments utilizing more than one threaded fastener 32, it will be appreciated that each threaded fastener 32 associated with the carrier member 162 would be threadedly engaged with respective threaded receptacles 118 to secure the carrier member 162 to the outboard road wheel 12.

For the system 160 as described above, when a given wear pad 14 becomes worn or damaged, it can be easily replaced with another wear pad 14 by removing the threaded fastener 32 and the lock ring member 106, removing the carrier member 162 corresponding to the worn or damaged wear pad 14 (by pushing or pulling the carrier member 162 axially outward), positioning a replacement carrier member 162 (along with its corresponding replacement wear pads 14) in the location vacated by the removed carrier member 162, and installing the lock ring member 106 and the threaded fastener 32 as described hereinabove. For embodiments utilizing more than one threaded fastener 32, it will be appreciated that each threaded fastener 32 associated with the carrier member 162 would be removed and then subsequently reinstalled. The replacement can be done without special tools, without having to take the tracked vehicle to a maintenance center or depot, and without having to remove the road wheel 12 from the tracked vehicle.

Although only one carrier member 162 is shown in FIGS. 13 and 14, it will be appreciated that according to other embodiments, the system 162 may include a plurality of carrier members 162.

In view of the above, it will be appreciated that the above-described wear pads 14 are replaceable, and that the systems shown in FIGS. 2-14 permit the easy replacement of wear pads 14 which are worn or damaged, in the field or in the shop, relatively quickly at a relatively inexpensive cost, without incurring any significant down time for the tracked vehicle.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

It is worthy to note that any reference to “one aspect,” “an aspect,” “one embodiment,” or “an embodiment” means that a particular feature, structure, or characteristic described in connection with the aspect is included in at least one aspect. Thus, appearances of the phrases “in one aspect,” “in an aspect,” “in one embodiment,” or “in an embodiment” in various places throughout the specification are not necessarily all referring to the same aspect. Furthermore, the particular features, structures or characteristics may be combined in any suitable manner in one or more aspects.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

What is claimed is:

1. A system, comprising:
a wheel; and
a plurality of carrier members removably connected to the wheel; and
a plurality of wear pads, wherein each carrier member has at least one of the wear pads connected thereto.

2. The system of claim 1, wherein the wheel is a road wheel of a tracked vehicle.

3. The system of claim 1, wherein:
the wheel defines a plurality of axial grooves; and
at least one of the carrier members defines a projection which is received by one of the axial grooves.

4. The system of claim 3, wherein a shape of the projection corresponds to a shape of the one of the axial grooves.

5. The system of claim 1, wherein at least one of the carrier members comprises at least one of the following:
a metal material;
a plastic material; and
a composite material.

6. The system of claim 1, wherein at least one of the carrier members is removably connected to the wheel by a snap fit connection.

7. The system of claim 1, further comprising a second wheel, wherein at least one of the carrier members is removably connected to the second wheel.

8. The system of claim 1, further comprising a plurality of fasteners, wherein at least one of the carrier members is removably connected to the wheel by at least one of fasteners.

9. The system of claim 8, wherein the at least one of the fasteners is threadedly engaged with the at least one of the carrier members.

10. The system of claim 8, further comprising a plurality of wear rings, wherein at least one of the wear rings is connected to the at least one of the fasteners.

11. The system of claim 10, wherein the at least one of the fasteners is threadedly engaged with the at least one of the wear rings.

12. The system of claim 1, further comprising a lock ring, wherein the lock ring is removably connected to the wheel.

13. The system of claim 12, further comprising a plurality of fasteners, wherein the lock ring is removably connected to the wheel by at least one of the plurality of fasteners.

14. The system of claim 1, wherein the at least one of the wear pads comprises an elastomeric material.

15. The system of claim 1, wherein the at least one of the wear pads is one of the following:
adhered to a corresponding carrier member;
bonded to a corresponding carrier member;
cured to a corresponding carrier member; and
over-molded onto a corresponding carrier member.

16. The system of claim 1, further comprising a plurality of fasteners, wherein at least one of the wear pads is connected to a corresponding carrier member by at least one of the fasteners.

17. A system, comprising:
a first wheel;
a second wheel axially aligned with the first wheel;
a carrier member removably connected to the first and second wheels;
a first wear pad connected to the carrier member and radially aligned with the first wheel; and
a second wear pad connected to the carrier member and radially aligned with the second wheel.

18. The system of claim 17, further comprising a lock ring removably connected to the first wheel, wherein the carrier member is removably connected to the first and second wheels by the lock ring.

19. The system of claim 18, further comprising a plurality of fasteners, wherein the lock ring is removably connected to the first wheel by at least one of the fasteners.

20. The system of claim 17, further comprising:
a plurality of carrier members removably connected to the first and second wheels;
a plurality of first wear pads; and
a plurality of second wear pads, wherein each carrier member has at least one first wear pad and at least one second wear pad connected thereto.
